(19) United States
(12) Patent Application Publication
(10) Pub. No.: US 2002/0146569 A1
(43) Pub. Date: Oct. 10, 2002

(54) Sliding article with electrode film, window glass with electrode film, and conductive paste

(75) Inventors: Akira Nagai, Kyotanabe-shi (JP); Haruhiko Kano, Muko-shi (JP); Daizou Inoue, Yokaichi-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 10/058,623

(22) Filed: Jan. 28, 2002

(30) Foreign Application Priority Data
Jan. 29, 2001 (JP) 2001-020439
Dec. 4, 2001 (JP) 2001-369943

(51) Int. Cl. B32B 9/00

(52) U.S. Cl. 428/428; 428/701

(57) ABSTRACT

A sliding article, such as a window glass, with an electrode film having superior wear resistance and sufficient film strength, includes a sliding member and an electrode film formed on the sliding member, the electrode film containing an inorganic material made of at least one material selected from the group consisting of niobium silicide, titanium silicide, and zirconium silicide. The electrode film is formed from a conductive paste which preferably includes a glass frit, an organic vehicle and the inorganic material.

### BACKGROUND OF THE INVENTION

1. Field of the Invention

The present invention relates to a sliding article with an electrode film, a window glass with an electrode film, and a conductive paste for forming an electrode film. In particular, the present invention relates to a conductive paste for forming a hot-wire heater in a window glass having an anti-fogging or defrosting function.

2. Description of the Related Art

Hitherto, window glasses having an anti-fogging or defrosting function, for example, rear window glasses of automobiles, have been provided with electrode films to function as hot-wire heaters. When such a window glass is in operation, there is sliding movement between the window and the frame thereof. This results in sliding between the electrode film and a seal member under the frame which is in contact with the electrode film. This, in turn, results in a large frictional force being generated between the electrode film and the window glass and, thereby, the electrode film is likely to become worn.

When the wear resistance of the electrode film formed on the portion, at which sliding is carried out frequently and repeatedly, is low, the electrical conductivity of the electrode film may vary so as to bring about variations in heat generation, and eventually, breaks may occur. Herein, the movable window glass refers to a general window glass capable of being slid up and/or down, from side to side, or the like by a drive unit provided separately or by manual power while the window glass is in contact with the seal member, etc.

Examples of measures for improving wear resistance include a method in which an electrode film is formed using a conductive paste, and thereafter, a coating of, for example, a Ni plating, having a relatively high hardness is formed on the electrode film. However, regarding this method, there have been problems in that the process has become complicated and in that the cost has increased due to an additional step of forming the coating.

### SUMMARY OF THE INVENTION

The present invention was made in order to overcome the aforementioned problems. Accordingly, it is an object of the present invention to provide a sliding article with an electrode film and a window glass with an electrode film, which are provided with electrode films having superior wear resistance and sufficient film strength, and to provide a conductive paste capable of forming these electrode films.

According to an aspect of the present invention, a sliding article with an electrode film is provided. The sliding article with an electrode film includes a sliding member and an electrode film formed on the sliding member. The electrode film contains an inorganic material made of at least one selected from the group consisting of niobium silicide, titanium silicide, and zirconium silicide.

In the sliding article with an electrode film according to the present invention, preferably, the aforementioned electrode film contains Ag as a conductive material.

Preferably, the aforementioned electrode film further contains a glass component. The aforementioned electrode film may further contain at least one pigment selected from the group consisting of copper oxide, silicon oxide, manganese oxide, iron oxide, and chromium oxide. At this time, preferably, the aforementioned inorganic pigment contains at least one selected from the group consisting of copper oxide and silicon oxide.

In the sliding article with an electrode film according to the present invention, the aforementioned electrode film may be formed from a coating of a conductive paste.

In the sliding article with an electrode film according to the present invention, the aforementioned sliding member may be a glass plate. In this case, the sliding member is a movable window glass.

According to another aspect of the present invention, a window glass with an electrode film is provided. The window glass with an electrode film includes a glass plate and an electrode film which is formed on the glass plate and which functions as a hot-wire heater. The electrode film contains at least one selected from the group consisting of niobium silicide, titanium silicide, and zirconium silicide.

In the window glass with an electrode film according to the present invention, preferably, the aforementioned electrode film contains Ag as a conductive material.

Preferably, the aforementioned electrode film further contains a glass component. The aforementioned electrode film may further contain at least one pigment selected from the group consisting of copper oxide, silicon oxide, manganese oxide, iron oxide, and chromium oxide. At this time, preferably, the aforementioned inorganic pigment contains at least one selected from the group consisting of copper oxide and silicon oxide.

In the window glass with an electrode film according to the present invention, the aforementioned electrode film may be formed from a coating of a conductive paste.

According to another aspect of the present invention, a conductive paste for forming the aforementioned electrode film is provided. The conductive paste includes a conductive material, a glass frit, an organic vehicle, and an inorganic material. The inorganic material is made of at least one selected from the group consisting of niobium silicide, titanium silicide, and zirconium silicide.

Preferably, the conductive paste according to the present invention contains 3 to 10 parts by weight of the aforementioned inorganic material relative to 100 parts by weight of the aforementioned conductive material.

Preferably, the aforementioned conductive paste contains Ag as a conductive material.

Preferably, the conductive paste according to the present invention further contains at least one pigment selected from the group consisting of copper oxide, silicon oxide, manganese oxide, iron oxide, and chromium oxide. More preferably, the inorganic pigment contains at least one selected from the group consisting of copper oxide and silicon oxide. Preferably, the conductive paste contains 0.1 to 3 parts by weight of the aforementioned inorganic pigment relative to 100 parts by weight of the aforementioned conductive material.

The sliding article with an electrode film having the aforementioned configuration according to the present invention has superior wear resistance and sufficient film strength. When it is applied to, for example, a movable window glass of an automobile, etc., an anti-fogging or defrosting function is sufficiently exhibited, and in addition to this, the electrode film is unlikely to peel.

The window glass with an electrode film having the aforementioned configuration according to the present invention is provided with superior wear resistance and sufficient film strength. When it is applied to, for example, a fixed window glass, an anti-fogging or defrosting function is sufficiently exhibited, and in addition to this, the electrode film is unlikely to peel.

Since the aforementioned electrode film contains Ag as a conductive material, a film can be formed even on a base material (sliding member, window glass) having a low melting point, such as glass, without degradation of the base material and, therefore, a sliding article with an electrode film and a window glass with an electrode film, each having superior wear resistance and sufficient film strength, can be provided.

Since the aforementioned electrode film contains the glass component, the adhesion property to the base material (sliding member, window glass) is improved and, therefore, a sliding article with an electrode film and a window glass with an electrode film, each having superior wear resistance and sufficient film strength, can be provided.

In particular, when the aforementioned electrode film contains the inorganic pigment made of copper oxide, silicon oxide, or copper oxide and silicon oxide, a sliding article with an electrode film and a window glass with an electrode film, each including an electrode film adjusted to have a desired color tone, can be provided.

Since the aforementioned electrode film is formed using the conductive paste, an electrode film having superior wear resistance and sufficient film strength can be formed with relative ease.

The conductive paste having the aforementioned configuration according to the present invention can provide a sliding article with an electrode film and a window glass with an electrode film, which have superior wear resistance and sufficient film strength, which sufficiently exhibit an anti-fogging or defrosting function when applied to, for example, a movable window glass of an automobile and a fixed window glass, and in addition to these, in which the electrode film is unlikely to peel.

In particular, when the conductive paste according to the present invention contains 3 to 10 parts by weight of the inorganic material relative to 100 parts by weight of the conductive material, a sliding article with an electrode film and a window glass with an electrode film can be provided, wherein superior wear resistance and sufficient film strength are exhibited, as is an anti-fogging or defrosting function when it is applied to, for example, a movable window glass of an automobile and a fixed window glass, and in addition, in which the electrode film is unlikely to peel.

Other features and advantages of the present invention will become apparent from the following description of the invention which refers to the accompanying drawings.

### BRIEF DESCRIPTION OF THE DRAWING(S)

FIG. 1 is a plan view of a sliding article with an electrode film according to an embodiment of the present invention.

FIG. 2 is a diagram of an electrode pattern according to an embodiment of the present invention.

### DETAILED DESCRIPTION OF EMBODIMENTS OF THE INVENTION

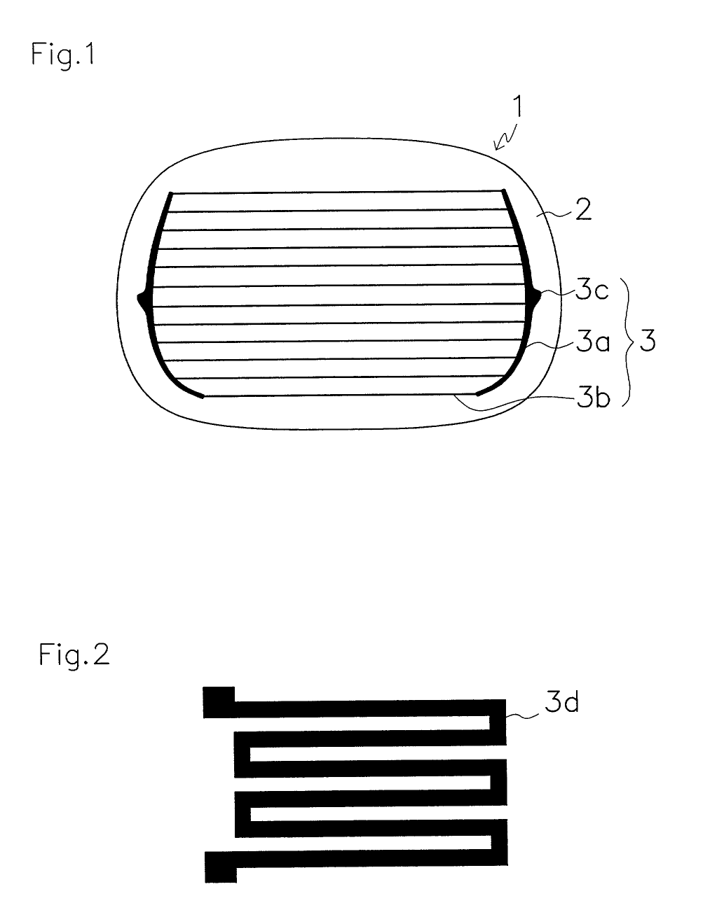

Regarding a sliding article with an electrode film according to the present invention, an embodiment thereof is described in detail with reference to FIG. 1.

In the present embodiment, a sliding article 1 with an electrode film is composed of a sliding member 2 and an electrode film 3.

The sliding member 2 is, for example, a glass plate, specifically, a window glass, and more specifically, a movable window glass. The sliding member 2 is provided in contact with another member (not shown), for example, a seal member under the frame of the window glass, and is slid by a drive unit (not shown) provided separately.

The electrode film 3 is a film formed on the sliding surface of the sliding member 2 and containing a conductive material. When the electrode film 3 functions as a hot-wire heater formed on the sliding member 2, for example, the electrode film 3 is provided with bus bars 3a, line electrodes 3b, and leading electrodes 3c.

The bus bars 3a are a pair of band-like electrode films formed in the neighborhood of both end portions of one primary surface of the sliding member 2 in the longitudinal direction thereof A plurality of line electrodes 3b are fine wire-like electrode films formed between the pair of bus bars 3a, and are formed nearly all over the primary surface of the sliding member 2. The leading electrodes 3c are a pair of electrode films and are formed in order to electrically connect to respective bus bars of the pair of bus bars 3a. The leading electrodes 3c are electrically connected to a power portion provided separately. The positions, shapes, and numbers of bus bars 3a, line electrodes 3b, and leading electrodes 3c are not limited to those shown in FIG. 1, and can be appropriately adjusted in accordance with the use of the sliding article.

The window glass with an electrode film according to the present invention has a configuration similar to that of the aforementioned sliding article 1. More specifically, a glass plate is used as the sliding member 2 in the sliding article 1 and, in a manner similar to that described above, the electrode film 3 functions as a hot-wire heater. The window glass with an electrode film may be, for example, a movable window glass for an automobile, and in addition to this, may be a general window glass for a housing, etc., regardless of whether it is movable or fixed.

The electrode films in the sliding article with an electrode film and window glass with an electrode film according to the present invention must contain an inorganic material made of at least one selected from the group consisting of niobium silicide, titanium silicide, and zirconium silicide. These inorganic materials have especially high hardnesses and contribute to improvement of wear resistance of the electrode films.

Although the conductive material contained in the electrode film is not specifically limited, for example, noble metals, such as Ag and Pd, and base metals, such as Ni, Cu, and Al, may be appropriately used alone or as a mixture thereof. When the sliding member is a glass plate, preferably, Ag is contained in consideration of the softening temperature of the sliding member.

The electrode film may further contain a glass component for the purpose of, for example, improving the adhesion strength to the sliding member. Although this glass component is not specifically limited, for example, when the sliding member, on which an electrode film is formed, is a glass plate, the glass component must have sufficient fluidity at a temperature in the neighborhood of the softening point of the glass plate. Examples of glass components include, for example, glass frits having softening points of 380° C. to 650° C., specifically, B—Si—Pb—O glass components, B—Si—Zn—O glass components, B—Si—Bi—O glass components, and the like. The content of the glass component in the electrode film can be appropriately adjusted in accordance with the desired characteristics for a particular use of the sliding article. For example, the content is preferably 1 to 20 parts by weight relative to 100 parts by weight of the conductive material, and more preferably, is 5 to 15 parts by weight.

The electrode film may further contain a pigment made of an oxide, for example, copper oxide, silicon oxide, manganese oxide, iron oxide, and chromium oxide, for the purpose of, for example, adjusting color tone, and the content thereof can be appropriately adjusted in accordance with the desired characteristics for a particular use of the sliding article. In particular, copper oxide, silicon oxide, or copper oxide and silicon oxide are preferable from the viewpoint of the affinity for niobium silicide, titanium silicide, and zirconium silicide. The contents of these inorganic pigments are preferably 0.1 to 3 parts by weight relative to 100 parts by weight of the conductive material, and more preferably, is 0.5 to 2 parts by weight.

The electrode film may further contain an organic metal, for example, organic rhodium, organic platinum, and organic nickel, for the purpose of, for example, adjusting coloring and resistance, and the content thereof can be appropriately adjusted in accordance with the desired characteristics for a particular use of the sliding article.

The method for forming the electrode film is not specifically limited. However, for example, when an electrode film of 1 to 10 mm in film thickness, which functions as a hot-wire heater on a glass plate, is formed, examples of methods include a method, although not shown in the drawing, in which a coating film of conductive paste is formed on the glass plate by screen printing, and thereafter, drying at 130° C. to 180° C. for 5 to 10 minutes and baking at 600° C. to 700° C. for 1 to 5 minutes are performed.

The conductive paste according to the present invention used for forming such an electrode film includes a conductive material, a glass frit, an organic vehicle, and an inorganic material. The inorganic material is made of at least one selected from the group consisting of niobium silicide, titanium silicide, and zirconium silicide.

Although the shape of the conductive material contained in the conductive paste according to the present invention is not specifically limited, for example, a spherical powder or an oblate powder may be appropriately used alone or as a mixture thereof. Although the average particle diameter is not specifically limited, for example, when the conductive material is a spherical Ag powder, the average particle diameter is preferably on the order of 0.1 to 5 mm. In this case, when the average particle diameter is 0.1 mm or more, since Ag is not excessively sintered, the stress applied is reduced even in the case where the sliding member, on which the electrode film is formed, is a glass plate. On the other hand, when the average particle diameter is 5 mm or less, since the state of sintered Ag becomes dense, the tensile strength of the electrode film formed is not reduced, and peeling of the electrode film is inhibited.

For example, when the conductive material is an oblate Ag powder, the average particle diameter is preferably on the order of 3 to 10 mm. In this case, when the average particle diameter is 3 mm or more, since the effect of reflecting visible light is not reduced, even in the case, for example, where the sliding member, on which the electrode film is formed, is a glass plate, a dark brown color tone of the electrode film when viewed from the reverse surface of the glass plate can be maintained. On the other hand, when the average particle diameter is 10 mm or less, since the state of sintered Ag becomes dense, the tensile strength of the electrode film formed is not reduced, and peeling of the electrode film is inhibited.

Although the material for the organic vehicle contained in the conductive paste according to the present invention is not specifically limited, examples of the aforementioned materials include an organic vehicle in which 1 to 40% by weight of organic binder, such as ethyl cellulose, nitrocellulose, and alkyd resin, is dispersed in an organic solvent, such as terpineol, butyl carbitol, and carbitol acetate. These materials can be appropriately adjusted in accordance with the desired characteristics for a particular use of the sliding article. The content of the organic vehicle can also be appropriately adjusted in accordance with the desired characteristics for a particular use of the sliding article in a manner similar to those in conventional conductive pastes.

The shape, particle diameter, and content of the inorganic material contained in the conductive paste according to the present invention are not specifically limited, and a spherical powder or an oblate powder may be appropriately used alone or as a mixture thereof while the content thereof is appropriately adjusted in accordance with the desired characteristics for a particular use of the sliding article. For example, when an electrode film which functions as a hot-wire heater is formed on a glass plate, the average particle diameter (D₅₀) is preferably on the order of 0.1 to 5.0 mm, and the content is preferably 3 to 10 parts by weight relative to 100 parts by weight of the conductive material in the conductive paste. When the average particle diameter is 0.1 mm or more, the resistivity of the electrode film formed becomes proper. On the other hand, when the average particle diameter is 5.0 mm or less, the surface roughness of the electrode film formed becomes proper and, therefore, the sliding property is not adversely affected. When the content is 3 parts by weight or more, the wear resistance of the electrode film formed is sufficiently improved and, therefore, the effects of the present invention are exhibited. On the other hand, when the content is 10 parts by weight or less, since the tensile strength of the electrode film formed is not reduced and becomes proper, peeling of the electrode film is unlikely to occur.

The conductive paste according to the present invention may further contain an inorganic pigment made of an oxide, for example, copper oxide, silicon oxide, manganese oxide, iron oxide, and chromium oxide for the purpose of, for example, adjusting color tone, and the content thereof can be appropriately adjusted in accordance with the desired characteristics for a particular use of the sliding article. In particular, copper oxide, silicon oxide, or copper oxide and silicon oxide are preferable from the viewpoint of the affinity for niobium silicide, titanium silicide, and zirconium silicide. The contents of these inorganic pigments are preferably 0.1 to 3 parts by weight relative to 100 parts by weight of the conductive material, and more preferably, is 0.5 to 2 parts by weight.

The conductive paste according to the present invention may further contain an organic metal, for example, organic rhodium, organic platinum, and organic nickel, for the purpose of, for example, adjusting coloring and resistance, and the content thereof can be appropriately adjusted in accordance with the desired characteristics for a particular use of the sliding article.

Although the method for manufacturing the conductive paste according to the present invention is not specifically limited, for example, the aforementioned conductive material, glass frit, organic vehicle, inorganic material, inorganic pigment, etc., are mixed beforehand, the resulting mixture is kneaded to make a paste, and thereby, the conductive paste can be produced.

### EXAMPLES

A spherical Ag powder A having an average particle diameter (D₅₀) of 0.3 mm, a spherical Ag powder B having an average particle diameter (D₅₀) of 2.0 mm, and an oblate Ag powder having an average particle diameter (D₅₀) of 4.0 mm were prepared as conductive materials, and niobium silicide, zirconium silicide, and titanium silicide were prepared as inorganic materials. A B—Si—Pb—O glass frit having a softening point of 460° C. and a B—Si—Bi—O glass frit having a softening point of 480° C. were prepared as the glass frits. Furthermore, an organic vehicle composed of 10% by weight of ethyl cellulose and 90% by weight of terpineol and an organic vehicle composed of 30% by weight of the total of nitrocellulose and alkyd resin and 70% by weight of carbitol acetate were prepared as organic vehicles, and copper oxide, silicon oxide, chromium oxide, and manganese oxide were prepared as inorganic pigments.

Subsequently, the aforementioned materials were mixed and kneaded at compounding ratios shown in the following Table 1, and thereby, conductive pastes of Samples 1 to 13 were prepared.

TABLE 1

| | Conductive material | | | Inorganic material | | | | | | | Inorganic | |
|---|---|---|---|---|---|---|---|---|---|---|---|---|
| | | Average | | | Average | | Glass frit | | Organic vehicle | | pigment | |
| | | particle | Parts | | particle | Parts | | Parts | | Parts | | Parts |
| Sam- | | diameter | by | | diameter | by | | by | | by | | by |
| ple | Type | (μm) | weight | Type | (μm) | weight | Type | weight | Type | weight | Type | weight |
| 1 | Spherical Ag | 0.3 | 50 | Niobium | 0.5 | 2 | Softening | 5 | Ethyl | 2.5 | Copper | 1.0 |
| 2 | powder A | | | silicide | | 3 | point | | cellulose | | Oxide | |
| 3 | and | | | | | 10 | 460° C. | | And | | and | |
| 4 | Spherical Ag | 2.0 | 50 | | | 12 | B-Si-Pb-O | | Terpineol | 22.5 | Silicon | 1.0 |
| 5 | powder B | | | Zirconium | 7 | | | | | | oxide | |
| | | | | silicide | | | | | | | | |
| 6 | | | | Titanium | | | | | | | | |
| 7 | Spherical Ag | 0.3 | 50 | silicide | | | | | | | | |
| | powder A | | | | | | | | | | | |
| | and | | | | | | | | | | | |
| | Oblate Ag | 4.0 | 50 | | | | | | | | | |
| | powder | | | | | | | | | | | |
| 8 | Spherical Ag | 0.3 | 50 | | | | *1 | | | | | |
| 9 | powder A | | | | | | Softening | 5 | *2 | | | |
| 10 | and | | | | | | point | | Ethyl | 2.5 | *3 | |
| 11 | Spherical Ag | 2.0 | 50 | | 3.0 | | 460° C. | | cellulose | | Copper | 1.0 |
| 12 | powder B | | | — | | | B-Si-Pb-O | | and | | Oxide | |
| 13 | | | | (Electroplated film) | | | | | Terpineol | 22.5 | and | |
| | | | | | | | | | | | Silicon | 1.0 |

oxide

*1 Softening point 480° C., B-Si-Bi-O glass frit 5 parts by weight
*2 The total of nitrocellulose and alkyd resin 7.5 parts by weight, carbitol acetate 17.5 parts by weight
*3 Chromium oxide 1.0 parts by weight, manganese oxide 1.0 parts by weigh

Each meandering pattern 3d (width of 0.4 mm, the total length of 200 mm including return lines), as shown in FIG. 2, of the conductive pastes of Samples 1 to 13 was applied on a slide glass substrate by screen printing. This was baked at 650° C. for 3 minutes so as to form an electrode film, and thereby, test samples of Samples 1 to 13 were produced. Regarding the test sample of Sample 13, an electroplated copper plating of about 5 mm in thickness was applied on the electrode film after baking, and furthermore, an electroplated nickel plating of about 2 mm in thickness was applied thereon, so that a two-layered plating film composed of a copper plating and nickel plating was formed.

Subsequently, regarding the test samples of Samples 1 to 13, the tensile strength and wear resistance of the electrode film were measured. The evaluation results thereof are shown in the following Table 2.

Regarding the tensile strength, terminals in the shape of the letter L made of a plate-like ribbon which had a width of 2 mm and a thickness of 0.1 mm and which was bent at the position 2 mm from the tip were joined using an epoxy adhesive with the end portions 2 mm square at both ends of the electrode film (line electrode) of the test sample shown in FIG. 2, and thereafter, a tensile strength was measured with a tensile testing machine.

Regarding the wear resistance, the initial resistance between the aforementioned end portions 2 mm square was measured. Subsequently, friction was applied repeatedly with #500 sandpaper of 10 mm in width, and the number of applications, at which the resistance was increased by 100% relative to the initial resistance, was recorded. Regarding the friction, a load of 1 kg was applied at 500 mm/min.

TABLE 2

| | Tensile strength | Wear resistance |
|---|---|---|
| Sample | (N) | (times) |
| 1 | 18 | 20 |
| 2 | 18 | 50 |
| 3 | 16 | 60 |
| 4 | 9 | 40 |
| 5 | 19 | 65 |
| 6 | 20 | 70 |
| 7 | 19 | 65 |
| 8 | 19 | 60 |
| 9 | 21 | 60 |
| 10 | 20 | 70 |
| 11 | 20 | 65 |
| 12 | 20 | 15 |
| 13 | 17 | 55 |

As is clear from Table 2, the wear resistance of the test samples of Samples 1 to 4 containing niobium silicide as an inorganic material are 20 to 60 times, and each of these samples exhibits superior tensile strength and wear resistance compared to the wear resistance (15 times) of the test sample of Sample 12 which is a comparative example containing no inorganic material. Among Samples 1 to 4, the test samples of Samples 2 and 3 containing 3 to 10 parts by weight of inorganic material relative to 100 parts by weight of the conductive material exhibit wear resistance of 50 to 60 times at a tensile strength of 16 to 18 N. These are nearly equivalent to the tensile strength (17 N) and wear resistance (55 times) of the test sample of Sample 13 which is a comparative example including an electroplated film and, therefore, Samples 2 and 3 exhibit superior tensile strength and wear resistance.

The test samples of Samples 5 to 11 containing 7 parts by weight of inorganic material relative to 100 parts by weight of the conductive material exhibit tensile strength of 19 to 21 N and wear resistance of 60 to 70 times regardless of the kind of inorganic material, kind of glass frit, kind of organic vehicle, and kind of inorganic pigment. These are nearly equivalent to the tensile strength (20 N) and wear resistance (15 times) of the test sample of Sample 12 which is a comparative example containing no inorganic material and, therefore, Samples 5 to 11 exhibit superior tensile strength and wear resistance. Furthermore, Samples 5 to 11 exhibit superior tensile strength and wear resistance compared to the tensile strength (17 N) and wear resistance (55 times) of the test sample of Sample 13 which is a comparative example including the electroplated film.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A sliding article comprising:
a sliding member; and
an electrode film formed on the sliding member,
wherein the electrode film comprises an inorganic material comprising at least one material selected from the group consisting of niobium silicide, titanium silicide, and zirconium silicide.

2. The sliding article according to claim 1, wherein the electrode film further comprises Ag as a conductive material.

3. The sliding article according to claim 1, wherein the electrode film further comprises a glass component.

4. The sliding article according to claim 1, wherein the electrode film further comprises at least one inorganic pigment selected from the group consisting of copper oxide, silicon oxide, manganese oxide, iron oxide, and chromium oxide.

5. The sliding article according to claim 4, wherein the inorganic pigment comprises at least one oxide selected from the group consisting of copper oxide and silicon oxide.

6. The sliding article according to claim 1, wherein the electrode film is formed from a coating of a conductive paste.

7. The sliding article according to claim 1, wherein the sliding member is a glass plate.

8. The sliding article according to claim 7, wherein the sliding member is a movable window glass.

9. A window glass comprising:
a glass plate; and
an electrode film which is formed on the glass plate and which functions as a hot-wire heater,
wherein the electrode film comprises at least one material selected from the group consisting of niobium silicide, titanium silicide, and zirconium silicide.

10. The window glass according to claim 9, wherein the electrode film further comprises Ag as a conductive material.

11. The window glass according to claim 9, wherein the electrode film further comprises a glass component.

12. The window glass according to claim 9, wherein the electrode film further comprises at least one inorganic pigment selected from the group consisting of copper oxide, silicon oxide, manganese oxide, iron oxide, and chromium oxide.

13. The window glass according to claim 12, wherein the inorganic pigment comprises at least one oxide selected from the group consisting of copper oxide and silicon oxide.

14. The window glass according to claim 9, wherein the electrode film is formed from a coating of a conductive paste.

15. A conductive paste for forming an electrode film, comprising:
a conductive material;
a glass frit;
an organic vehicle; and
an inorganic material,
wherein the inorganic material comprises at least one material selected from the group consisting of niobium silicide, titanium silicide, and zirconium silicide.

16. The conductive paste according to claim 15, comprising 3 to 10 parts by weight of the inorganic material relative to 100 parts by weight of the conductive material.

17. The conductive paste according to claim 15, further comprising Ag as a conductive material.

18. The conductive paste according to claim 15, further comprising at least one inorganic pigment selected from the group consisting of copper oxide, silicon oxide, manganese oxide, iron oxide, and chromium oxide.

19. The conductive paste according to claim 18, wherein the inorganic pigment comprises at least one oxide selected from the group consisting of copper oxide and silicon oxide.

20. The conductive paste according to claim 18, comprising 0.1 to 3 parts by weight of the inorganic pigment relative to 100 parts by weight of the conductive material.
